(19) United States
(12) Patent Application Publication
(10) Pub. No.: US 2008/0074788 A1
(43) Pub. Date: Mar. 27, 2008

(54) Data storage system with media having shape memory alloy protected layer

(76) Inventors: Chao Yuan Chen, San Jose, CA (US); Xiaoguang Ma, Fremont, CA (US); Michael Sullivan, Fremont, CA (US)

Correspondence Address: IRELL & MANELLA LLP, 840 NEWPORT CENTER DRIVE, SUITE 400, NEWPORT BEACH, CA, 92660, US

(21) Appl. No.: 11/525,293

(22) Filed: Sep. 21, 2006

(51) Int. Cl. G11B 5/82

(52) U.S. Cl. 360/135

(57) ABSTRACT

A disk for a hard disk drive. The disk includes a protective layer of shape memory alloy material over a magnetic layer. Contact between a head of the drive and the shape memory alloy material will cause frictional heat. The heat will cause a solid-solid phase transformation of the shape memory alloy material that will absorb energy and reduce wear. After head-disk contact terminates the shape memory alloy material will resume its initial solid phase. The shape memory alloy material may be relatively thin thereby improving the magnetic characteristics of the disks while providing a protective coating.

### BACKGROUND OF THE INVENTION

1. Field of the Invention

The subject matter disclosed generally relates to disk media of hard disk drives.

2. Background Information

Hard disk drives contain a plurality of heads that are magnetically coupled to rotating disks. The heads write and read information by magnetizing and sensing the magnetic fields of the disk surfaces.

The heads can be moved across the surfaces of the disks by a voice coil motor of the disk drive. The disks are rotated by a spindle motor so that different disk areas can be accessed by the heads. Additionally, the rotating disks create a flow of air that interacts with air bearing surfaces of the heads to create air bearings between the heads and the disk surfaces. The air bearings prevent mechanical contact between the heads and the disks. Mechanical contact can damage the disk surfaces.

When the disk drive is powered down the heads are typically rested onto a landing zone of the disks. When the drive is powered back on the disks are once again rotated and air bearings are formed to lift the heads from the disk surfaces. The landing and take-off of the heads results in mechanical wear of the disks.

The disks are typically covered with a protective coating of diamond-like-carbon (“DLC”) material. FIG. 1 shows a disk 1 of the prior art. The disk 1 includes a substrate 2 that supports a layer of magnetic material 3. The magnetic layer 3 may actually include multiple layers of magnetic material and non-magnetic material. Covering the magnetic material is a layer of diamond-like-carbon (“DLC”) 4. A layer of lubricant 5 may be applied to the outer surface of the disk to reduce friction between the disk 1 and an adjacent head.

Some heads are constructed from a carbon material. The DLC layer creates a carbon-carbon contact between the heads and the disks. This causes wear and other tribological problems. The DLC must be relatively thick to compensate for such wear. Unfortunately, increasing the thickness of the DLC reduces the magnetic properties of the disks. It would be desirable to provide a disk media that is resistant to mechanical wear and has favorable magnetic properties.

### BRIEF SUMMARY OF THE INVENTION

A disk for a hard disk drive. The disk includes a magnetic layer adjacent to a substrate. Adjacent to the magnetic layer is a layer of shape memory alloy material.

### BRIEF DESCRIPTION OF THE DRAWINGS

FIG. 1 is an illustration showing the various layers of a disk of the prior art;

FIG. 2 is a top view of a hard disk drive;

FIG. 3 is an illustration of a disk of the hard disk drive;

FIG. 4 is an illustration of a specific embodiment of the disk.

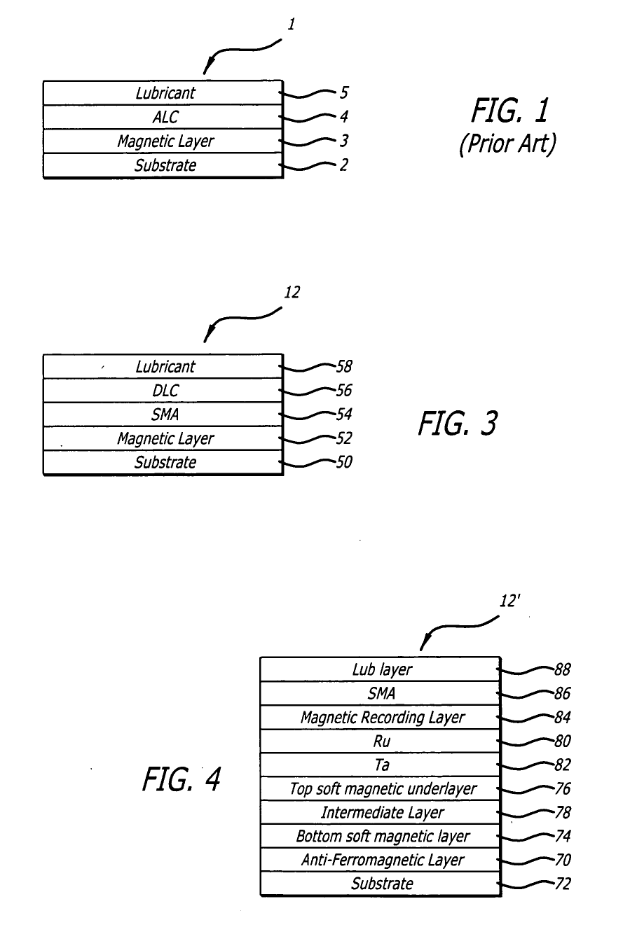

### DETAILED DESCRIPTION

Disclosed is a disk for a hard disk drive. The disk includes a protective layer of shape memory alloy material over a magnetic layer. Contact between a head of the drive and the shape memory alloy material will cause frictional heat. The heat will change the crystallographic phase of the shape memory alloy material. This phase transformation process will absorb energy and reduce wear. After head-disk contact terminates the shape memory alloy material will resume its initial solid phase. The shape memory alloy material may be relatively thin thereby improving the magnetic characteristics of the disks while providing a protecting coating.

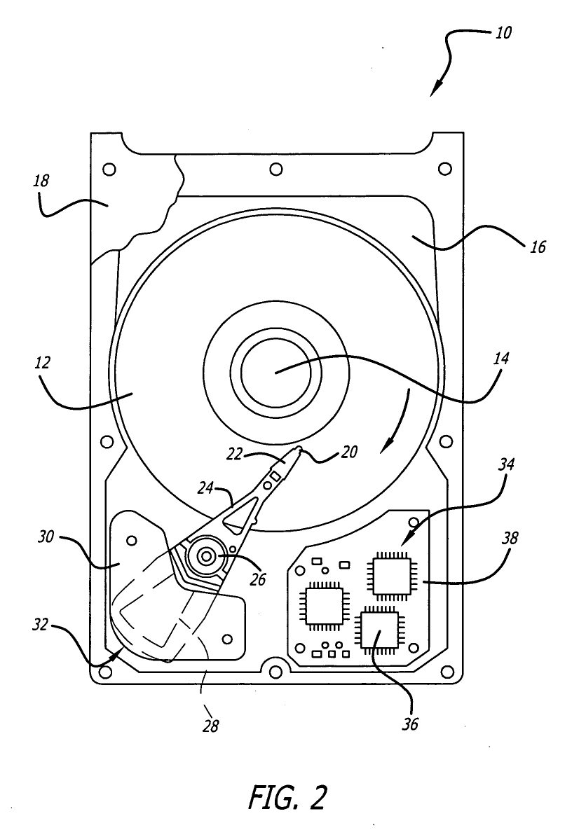

Referring to the drawings more particularly by reference numbers, FIG. 2 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

FIG. 3 shows an embodiment of the disk 12. The disk 12 includes a substrate 50 that supports a layer of magnetic material 52. Covering the magnetic material 52 is a layer of shape memory alloy material 54. The shape memory alloy material 54 may be constructed from a material that can undergo a solid-solid phase transformation. By way of example, the shape memory alloy 54 may be a material that includes nickel and titanium and is typically sold under the name NITINAL. The shape memory alloy 54 may have a thickness between 3-25 angstroms.

Alternatively, a layer of SMA material may be located between the substrate 50 and the magnetic layer 52, in addition to, or alternatively to the SMA layer 54. The SMA 54 can be covered with a layer of DLC material 56 and a layer of lubricant 58. The SMA material between the substrate 50 and magnetic layer 52 may have a thickness between 3 angstroms to 1 mm.

When a head 20 makes contact with a rotating disks the contact will cause thermal energy. The thermal energy causes the shape memory alloy material 54 to change phase to a more compliant material. The phase transformation absorbs the mechanical energy of the head-disk contact. After the head-disk contact event is terminated the shape memory alloy 54 reverts back to the original solid phase.

The layer of shape memory alloy material 54 may be relatively thin to improve the magnetic characteristics of the disks. By way of example, the layer of shape memory alloy material 54 may have a thickness between 3 and 10 mm. The shape memory alloy material 54 may be covered with a layer of lubricant 56 to reduce the friction between head 20 and the disk 12.

FIG. 4 shows an example of a disk 12′ that is used for perpendicular recording. The embodiment shown in FIG. 4 is exemplary and is not intended to limit the scope of the claims. The disk 12′ may include a layer of anti-ferromagnetic material 70 located over a substrate 72. A bottom soft magnetic underlayer 74 may be located over and contiguous with the anti-ferromagnetic material 70. The bottom soft magnetic underlayer 74 may be separated from a top soft magnetic underlayer 76 by an intermediate layer 78.

By way of example, the anti-ferromagnetic material may be constructed from a platinum and manganese composition PtMn, or an iridium and manganese composition IrMn. By way of example, the IrMn may be by atomic 20% iridium and 80% manganese. The synthetic AFC type soft magnetic layers 74 and 76 are pinned by the anti-ferromagnetic layer to increase the SNR. The SNR is improved by lowering the DC noise and spike noise within the soft magnetic layers 74 and 76 of the media.

It has been found that the media provides a higher SNR if the bottom soft magnetic underlayer 74 has a high magnetic saturation characteristic and the top soft magnetic underlayer 76 has a low magnetic saturation characteristic. By way of example, the bottom soft magnetic underlayer 74 may be constructed with cobalt, zirconium and niobium CoZrNb. The top soft magnetic underlayer 76 may be constructed from nickel, iron and niobium NiFeNb. The intermediate layer may be constructed from ruthenium.

The media may further include layers of ruthenium 80 and tantalum 82 adjacent to the top soft magnetic under layer 76. The media may also include magnetic recording layer 84.

A layer of shape memory alloy 86 covers the magnetic recording layer 84. To reduce friction between the head and the disk, the outer disk surface may include a layer of lubricant 88.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A magnetic disk for a hard disk drive, comprising:
a substrate;
a magnetic layer adjacent to said substrate; and,
a layer of shape memory alloy material adjacent to said magnetic layer.

2. The disk of claim 1, further comprising a lubricant adjacent to said layer of shape memory alloy material.

3. The disk of claim 1, wherein said shape memory alloy material includes nickel and titanium.

4. The disk of claim 1, wherein said shape memory alloy material has a thickness between 3 and 25 angstroms.

5. The disk of claim 1, wherein said shape memory alloy material is contiguous with said magnetic layer.

6. The disk of claim 5, wherein said shape memory alloy material is contiguous with said substrate.

7. A hard disk drive, comprising:
a base plate;
a spindle motor coupled to said base plate;
a disk coupled to said spindle motor, said disk including;
a substrate;
a magnetic layer adjacent to said substrate;
a layer of shape memory alloy material adjacent to said magnetic layer;
an actuator arm mounted to said base plate;
a voice coil motor coupled to said actuator arm; and,
a head coupled to said actuator arm and said disk.

8. The disk drive of claim 7, further comprising a lubricant adjacent to said layer of shape memory alloy material.

9. The disk drive of claim 7, wherein said shape memory alloy material includes nickel and titanium.

10. The disk drive of claim 7, wherein said shape memory alloy material has a thickness between 3 and 25 angstroms.

11. The disk drive of claim 7, wherein said shape memory alloy material is contiguous with said magnetic layer.

12. The disk drive of claim 11, wherein said shape memory alloy material is contiguous with said substrate.

13. A method for fabricating a disk of a hard disk drive, comprising:
forming a layer of magnetic material over a substrate; and,
forming a layer of shape memory alloy material over the layer of magnetic material.

14. The method of claim 9, further comprising forming a layer of lubricant over the layer of shape memory alloy material.

15. The method of claim 13, wherein the shape memory alloy material includes nickel and titanium.

16. The method of claim 13, wherein the shape memory alloy material has a thickness between 3 and 25 angstroms.

17. The method of 13, wherein the shape memory alloy material is formed contiguous to the magnetic material.

18. The method of claim 17, wherein the shape memory alloy material is formed contiguous to the substrate.
